(19) United States
(12) Patent Application Publication
(10) Pub. No.: US 2017/0217247 A1
(43) Pub. Date: Aug. 3, 2017

(54) Surface mounting 3D printed objects to encaustic

(71) Applicant: Joel David Anderson, Houston, TX (US)

(72) Inventor: Joel David Anderson, Houston, TX (US)

(21) Appl. No.: 15/014,693

(22) Filed: Feb. 3, 2016

(51) Int. Cl. B44C 3/12

(52) U.S. Cl. CPC B44C 3/12

(57) ABSTRACT

3D printed objects can be securely surfaced mounted onto encaustic artwork through a method of attaching anchor posts to the objects, softening the artwork in a controlled manner, surface attaching the objects, and controlled cooling of the artwork. Surface-mounted objects provide a different aesthetic than objects affixed to the artwork substrate as those often may appear sunken in the artwork.

### TECHNICAL HELD

The subject matter is related to incorporating 3D printed objects into artwork.

### BACKGROUND

Encaustic artworks are works which utilize beeswax mixed with typically damar resin acting as a hardener as their primary medium. Artist Jasper Johns's “Flag” hanging at New York's Museum of Modern Art is perhaps one of the most famous encaustics.

The composition of the encaustic medium does not naturally bond with thermoplastics—one cannot fuse these two components together. Therefore there needs to be some alternative method of securing 3D printed thermoplastics to the artwork.

One obvious method is to simply glue or screw the 3D printed object to the artwork substrate and paint around it. This is effective but gives the object a semi-submerged appearance. A cleaner/crisper effect would be achieved if the 3D printed object could be mounted/secured to the top of the artwork, over the encaustic.

### SUMMARY

A process for surface mounting 3D printed objects to encaustic art is disclosed. This involves adding anchor posts to the underside of 3D printed objects, controlled heating of the encaustic artwork, application of the 3D printed object, and controlled cooling.

The result of this process is a cleaner, more aesthetically pleasing appearance of the 3D printed object in the artwork, particularly where elements of the art pass under the object. As an example, an image transfer of a blank musical score can be laid down on the encaustic and then with this process 3D printed musical symbols with these bottom posts can be precisely mounted onto the artwork.

### DESCRIPTION OF DRAWINGS

FIG. 1 depicts the anchor post

FIG. 2 is a side-view depiction the 3D printed object anchored into the encaustic

FIG. 3 depicts the anchor posts attached to the 3D printed object

### DETAILED DESCRIPTION

The process of surface mounting 3D printed objects to encaustic artwork is comprise of 4 elements:
1) Creating size-appropriate anchor posts in your 3D software and attaching these to the underside of the object in the software for a secure bond.
2) Warming the encaustic artwork to the point where the encaustic medium has softened sufficiently.
3) Pushing the 3D printed object, post-side down, into the softened encaustic such that the medium wraps around the bottom bell part of the post.
4) Cooling the artwork in a way that the anchor post remains firmly affixed.

### Anchor Posts

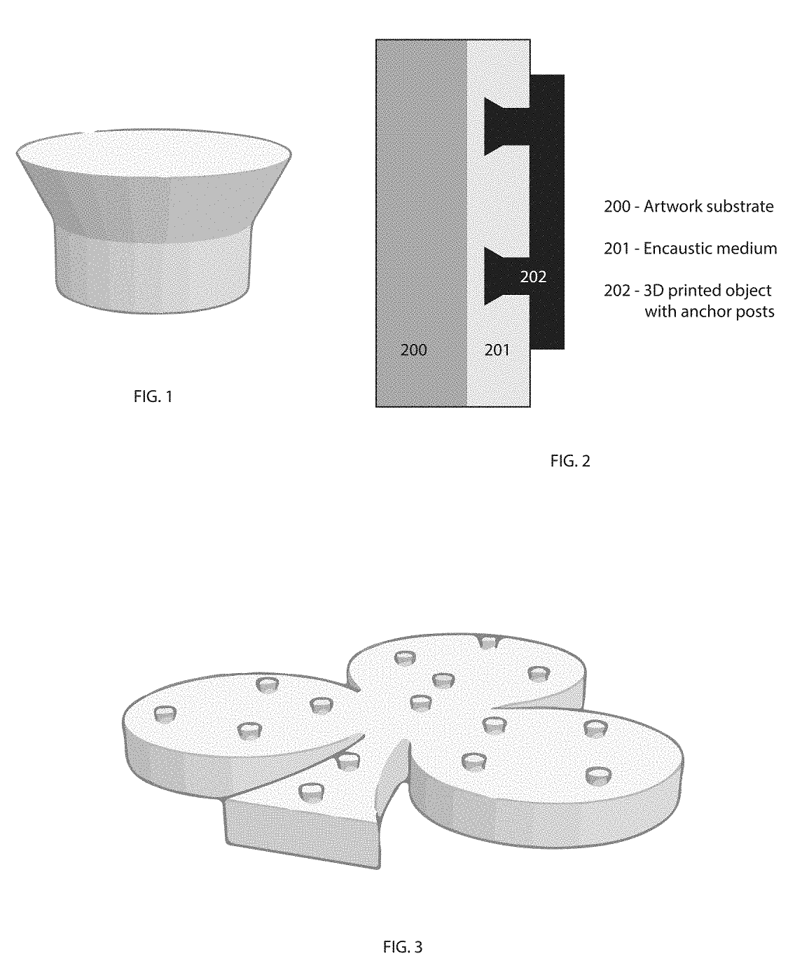

In FIG. 1 an anchor post is depicted. The anchor post will typically be cylindrical with a flared bottom. As the post will be concealed under the 3D printed object you will want them sizeable enough to hold into the encaustic but not too large as to impede their submersion. A width of 0.2″ is typical. As to the length of the posts: this will depend on the thickness of the encaustic on the artwork. Assuming an encaustic depth of ⅛″ on your artwork your anchor post should be approximately 1/32″ shorter. FIG. 2. shows a side view of the artwork with the substrate (200), the layers of encaustic medium (201), and the 3D printed object with anchor posts (203) embedded down into the encaustic.

The anchor posts should then be attached to your main object, using your 3D design software to attach them. You will want multiple anchor posts distributed evenly in order to provide an even adhesion throughout the object. FIG. 3 shows anchor posts attached to the bottom of a ⅜″ Ace of Clubs object evenly. The object is ready to be 3D printed.

### Warming of the Encaustic

The objective of this element of the process is to soften the encaustic on the artwork to a point where one can push down the 3d printed object, anchor-posts-down, into the encaustic layer.

Encaustic media has a melting point of around 170-180 degrees Fahrenheit, depending on the beeswax to damar mix ratios. Short of a complete melting of the medium, a good softening state for the purposes of this process is between 100 and 130 degrees Fahrenheit. Options for getting to this state include:
Placing the artwork, typically the smaller pieces, into a household oven, and using an adjacent thermometer to closely control the interior heat to 100-130 degrees Fahrenheit.
Placing the artwork in direct sunlight on TREX decking in the middle of the summer heat, again with an adjacent thermometer monitoring the heat.
Using a blow torch or heat gun to evenly heat the surface of the artwork.

Use a toothpick to test the softness of the encaustic on the area where the 3D printed object is to be applied.

### Attaching the 3D Printed Object to the Encaustic Artwork

With the artwork in the softened state, press the 3D printed object, anchor-post-down, evenly and firmly into the encaustic. There is little room for adjustment at this point. Ensure that the bottom surface of the 3D printed object is flush against the encaustic around all the edges of the 3D printed object.

### Controlled Cooling of the Artwork

The objective of this element is to keep the 3D printed object stabilized in the artwork while the encaustic enveloping the bottom bell-shaped areas of the anchor posts solidifies.

With the 3D object now surface mounted onto the artwork, apply weights if possible atop the 3D printed objects in order to keep them from moving and destabilizing the anchor posts as the encaustic hardens.

Allow the artwork to cool slowly and naturally. If you had it outdoors under the sun, move it first to the shade and then indoors to cool to room temperature. Feel the underside of the encaustic artwork as the top may appear cool but the interior and underside of the artwork may still be soft and the encaustic still pliable, particularly in the center.

Once fully cooled to room temperature, remove any weights from the tops of the 3D printed objects.

1. A method for the attachment of 3D printed objects to the surface of encaustic artwork, comprising the steps of:
a) creating and attaching anchoring posts to the 3D printed object,
b) warming the artwork to the state at which the encaustic has softened sufficiently,
c) physically mounting the 3D printed object into the artwork, and
d) controlled cooling of the artwork,
whereby a 3D printed object is securely affixed to the surface of an encaustic/mixed media artwork.
